(19) United States
(12) Patent Application Publication
(10) Pub. No.: US 2006/0227551 A1
(43) Pub. Date: Oct. 12, 2006

(54) Light blocking slot in a printed circuit board

(75) Inventor: Kenneth A. Houck, Sterling Heights, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/391,841

(22) Filed: Mar. 29, 2006

Related U.S. Application Data
(60) Provisional application No. 60/669,781, filed on Apr. 8, 2005.

(51) Int. Cl. F21V 33/00

(52) U.S. Cl. 362/253

(57) ABSTRACT

A circuit board assembly includes a light receiving surface that is capable of transmitting light through the circuit board. The light receiving surface is part of an opening within which an illumination device such as a light bulb is positioned. A slot or other opening is disposed between the light receiving surface and an area of the circuit board in which illumination is not desired. The slot prevents the transmission of light through the thickness of the circuit board and thereby provides for the blocking of light into areas of the circuit board that it is not desired.

### CROSS REFERENCE TO RELATED APPLICATION

The application claims priority to U.S. Provisional Application No. 60/669,781 which was filed on Apr. 8, 2005.

### BACKGROUND OF THE INVENTION

This invention generally relates to circuit board including a light emitting device. More particularly, this invention relates to a circuit board including light controlling features.

A conventional circuit board can include an opening through which a light bulb or other illumination device is positioned. The opening includes a light receiving surface through which light is transmitted from the light illuminating source into the circuit board. The circuit board is comprised of a material that transmits light outwardly into the circuit board and that illuminates portions of the board that may not be desired to be illuminated. The light transmitted through the board is most visible at edge areas and openings for connecting electrical components to the circuit board. Further, the surface of the circuit board can be illuminated such that open areas can undesirably appear illuminated. The uncontrolled transmission of light through the circuit board can cause undesired illumination in selected areas.

For these reasons, some circuit boards are coated or plated with a coating to prevent undesired illumination through the surface of the circuit board in specific areas. Disadvantageously, the coating or plating is applied after the circuit board is fabricated and cut to a desired shape. The coating or plating process is therefore performed as an additional step that requires additional processing time at additional cost.

Accordingly, it is desirable to develop a method and device for controlling light transmission through a circuit board without additional processing steps.

### SUMMARY OF THE INVENTION

An example circuit board according to this invention includes a light controlling opening disposed between a light source and an area where illumination of the circuit board is not desired.

An example circuit board according to this invention utilizes a slot disposed within the circuit board between a light source and an area that is not desired for illumination. The circuit board transmits light received through a surface or edge outwardly from the light source unless disrupted. The slot disrupts the transmission of light and controls light transmission within the circuit board.

An example according to this invention includes a Circuit board for illuminating a turn signal. The circuit board includes a light bulb mounted within an opening. A light emitting diode (LED) is mounted to the circuit board for selectively illuminating a turn signal. Illumination of the circuit board from the light bulb mounted within the opening can undesirably illuminate the area beneath the turn signal causing a partial appearance that the turn signal is on. The example circuit board according to this invention includes the slot between the opening for the light bulb and the indicator area. The slot interrupts and substantially prevents the transmission of light through the circuit board to the indicator area.

Accordingly, a circuit board according to this invention provides for the selective blocking of light to prevent undesired illumination in specific areas of a circuit board without substantial additional processing steps.

These and other features of the present invention can be best understood from the following specification and drawings, the following of which is a brief description.

### BRIEF DESCRIPTION OF THE DRAWINGS

FIG. 1 is schematic view of a prior art circuit board illustrating the transmission of light from an opening for a light bulb.

FIG. 2 is a schematic view of an example circuit board according to this invention including a slot for controlling light transmission.

FIG. 3 is top view of an example circuit board assembly according to this invention.

FIG. 4 is a perspective view of the example circuit board assembly according to this invention.

FIG. 5 is a cross-sectional view of the example circuit board according to this invention.

### DETAILED DESCRIPTION OF THE PREFERRED EMBODIMENT

Referring to Prior art FIG. 1, a conventional circuit board 15 includes an opening 16 for a light source 32. Light from the light source 32 within the opening 16 is transmitted through a light receiving surface 14. Light (indicated by arrows 22) transmitted through the light receiving surface 14 radiates outward from the opening 16 through a thickness 20 of the circuit board 15. The light 22 illuminates a surface of the circuit board 15 in an uncontrolled manner.

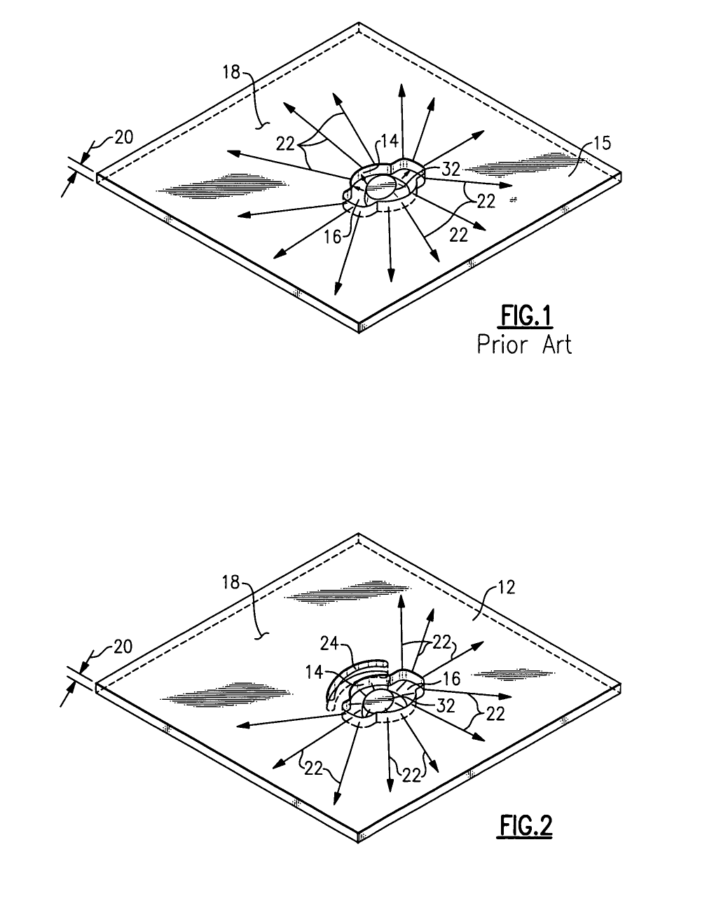

Referring to FIG. 2, an example circuit board 12 includes the opening 16 with light receiving surfaces 14. The opening 16 is provided for receiving the light bulb 32. The light bulb 32 transmits light, indicated by arrows 22, in a direction radiating outward from the light receiving surface 14 of the opening 16. The circuit board 12 also includes an indicator area 18. The indicator area 18 is not desired to receive illumination that is transmitted through the circuit board 12. The indicator area 18 does not receive light 22 transmitted through the circuit board 12 because light is blocked by a slot 24. The slot 24 is disposed between the indicator area 18 and the opening 16. The slot 24 is a barrier through which light 22 may not be transmitted.

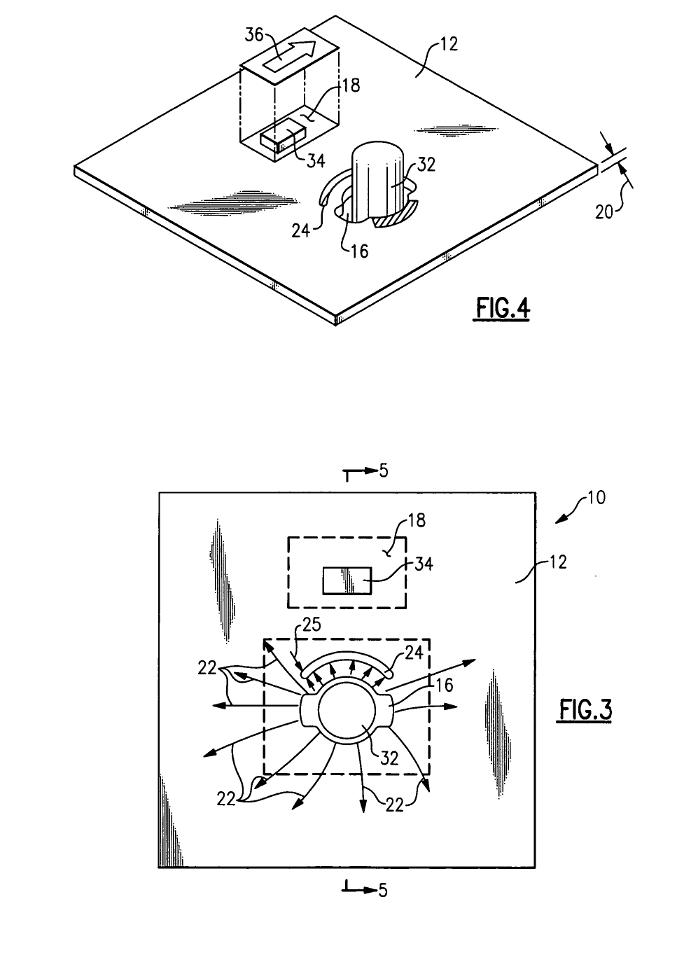

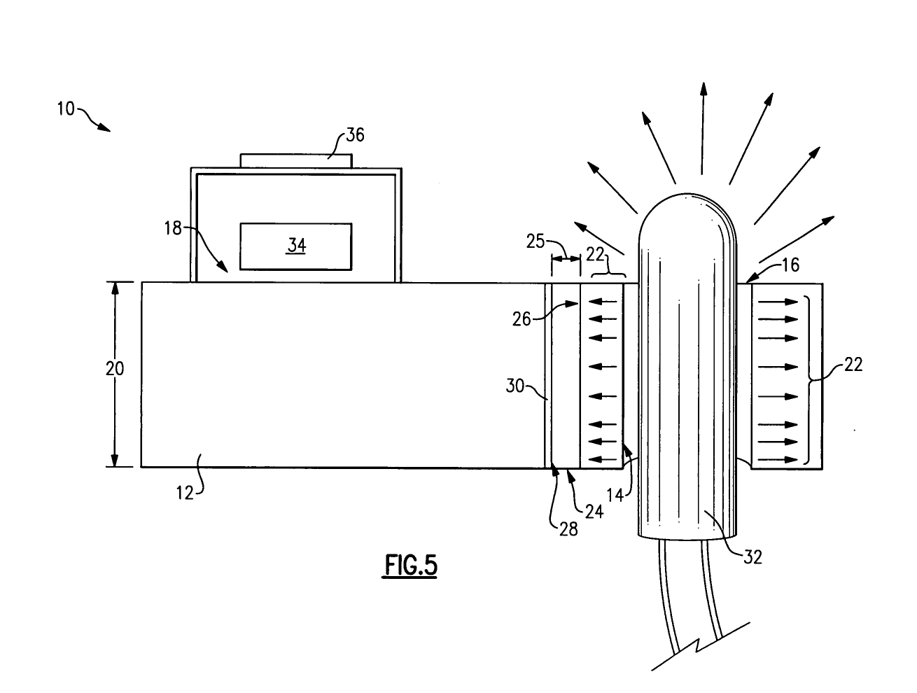

Referring to FIGS. 3 and 4, a circuit board assembly 10 according to this invention includes the circuit board 12 with the opening 16 for the light bulb 32. The light bulb 32 is provided for illumination of a dashboard component (not shown). The circuit board 12 also includes a light emitting diode 34 for the selective illumination of a turn signal indicator 36. It is desired that light not be transmitted through the circuit board 12 into the indicator area 18. Light transmitted through the circuit board 12 into the indicator area could provide a false or undesirable illumination of the indicator arrow 36 when the turn signal is not desired to be illuminated.

The circuit board 12 includes the slot 24 between the opening 16 and the indicator area 18. The slot 24 is an open space through which light is not transmitted to such a magnitude that would cause further illumination through the circuit board 12. The example slot 24 is semi-circular to generate a shadow or non-illuminated area that includes the indicator area 18.

The shape of the slot 24 provides the desired blocking effect to create the non-illuminated area of the circuit board 12. The slot 24 includes a width 25 determined to prevent and block the transmission of light past the slot 24. As appreciated, although the slot 24 is illustrated as an example, other opening shapes that prevent the transmission of light and provide the desired non-illuminated region of the circuit board 12 are also within the contemplation of this invention. Further, several slots can be disposed about the opening to further block transmission of light to other areas of the circuit board 12.

Referring to FIG. 5, a cross sectional view of the circuit board assembly 10 illustrates a thickness 20 through which the light 22 is transmitted from the light receiving surface 14. The slot 24 provides a barrier through which the light 22 may not be transmitted. The slot 24 includes a first side 26 that is disposed adjacent the side of the circuit board through which light is transmitted. A second side 28 as is disposed across the open space provided by the slot 24 and opposite the first side 26. The space between the first side 26 and the second side 28 is of the width 25 determined to prevent the transmission of the light 22 through the open space and back through the circuit board 12 through the second side 28.

The slot 24 is disposed between the opening 16 for the light bulb 32 and the indicator area 18. The indicator area 18 is disposed substantially under a LED light 34 that is arranged to selectively illuminate a turn signal indicator 36. The example slot 24 is disposed between the opening 16 and the indicator area 18.

Although a slot is shown other openings sizes and shapes as is required for application specific requirements are within the contemplation of this invention. Further, the slot may surround substantially the entire opening 16 except for those areas required to provide structural support for the opening 16 to prevent light from being transmitted throughout the entire circuit board 12.

The example slot 24 includes a coating 30 on the second side 28. The coating 30 on the second side 28 prevents illumination from other sources from being transmitted into the slot 24 and through the circuit board 12. The coating 30 is required in instances where light may be transmitted into the slot 24 from other light sources disposed such that light is reflected into the slot 24 from above the circuit board 12. In such instances, the coating 30 prevents the second side 28 from becoming a light receiving surface that could undesirably transmit light 22 through the circuit board 12.

The coating 30 may be of any consistency and material that would provide the desired blocking benefits and prevention of light from transmitting through the second surface 28 and into the thickness 20 of the circuit board 12.

Accordingly, the inventive circuit board assembly includes the slot 24 that effectively blocks undesired illumination from sources that could potentially impinge on areas of a circuit board where light is not desired. Further, the circuit board assembly according to this invention does not require expensive secondary operations as the slots may be fabricated during manufacture of the circuit board during fabrication of openings and other connector cut outs during manufacture.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A circuit board assembly comprising:
a light receiving surface capable of transmitting light through the circuit board; and
an opening for controlling light transmission disposed between the light receiving surface and a portion where illumination of the circuit board is not desired.

2. The circuit board assembly as recited in claim 1, wherein the light receiving surface is part of an opening within the circuit board.

3. The circuit board assembly as recited in claim 1, wherein the opening comprises a slot.

4. The circuit board assembly as recited in claim 1, wherein the opening includes a width determined to prevent the transmission from light across the opening.

5. The circuit board assembly as recited in claim 1, wherein the opening partially surrounds the light receiving surface.

6. The circuit board assembly as recited in claim 1, including a first light source transmitting light that is received by the light receiving surface.

7. The circuit board assembly as recited in claim 6, wherein the portion of the circuit board where illumination is not desired includes a second light source.

8. The circuit board assembly as recited in claim 7, wherein the second light source comprises a light emitting diode for illuminating a turn signal indicator.

9. The circuit board assembly as recited in claim 1, wherein light is transmitted from the light receiving surface through a thickness of the circuit board.

10. The circuit board assembly as recited in claim 1, wherein the light receiving surface is disposed transversely to a mounting surface of the circuit board.

11. The circuit board assembly as recited in claim 1, wherein the opening includes sides, and the sides include a coating preventing transmission of light from a light source into the circuit board.

12. An indicator assembly comprising:
a circuit board including a light receiving surface capable of transmitting light through the circuit board;
an indicator area of the circuit board including an indicator light for selectively illuminating an indicator signal; and
an opening within the circuit board disposed between the light receiving surface and the indicator area for controlling light transmission through the circuit board into the indicator area.

13. The assembly as recited in claim 12, wherein the light receiving surface is part of a cutout for a light source.

14. The assembly as recited in claim 12, wherein the opening comprises a slot including a width determined to prevent the transmission of light across the slot.

15. The assembly as recited in claim 12, wherein the opening includes a first surface that receives light through the circuit board and a second surface spaced apart from the first surface that does not receive or transmit light through the circuit board.

16. The assembly as recited in claim 15, wherein the second surface includes a coating for blocking light transmission into the circuit board.

17. The assembly as recited in claim 12, wherein the coating comprises a plating.
